(19) United States
(12) Patent Application Publication
(10) Pub. No.: US 2011/0303194 A1
(43) Pub. Date: Dec. 15, 2011

(54) SYSTEM AND METHOD OF IMPROVING EFFICIENCY OF COMBUSTION ENGINES

(75) Inventors: Sze Chun FONG, Hong Kong (HK); Chi Long Daniel LAM, Hong Kong (HK)

(73) Assignee: HANDSOME VIVA INVESTMENTS LIMITED, Hong Kong (CN)

(21) Appl. No.: 13/018,436

(22) Filed: Feb. 1, 2011

Related U.S. Application Data
(60) Provisional application No. 61/354,732, filed on Jun. 15, 2010.

(51) Int. Cl. F02M 51/00

(52) U.S. Cl. 123/486

(57) ABSTRACT

A system for improving the performance of a combustion engine comprising a system control unit is disclosed. The system control unit comprises an input module, a transform module and a control module all interconnected to each other. The input module obtains a first set of combustion parameters of the engine through at least one sensor. The transform module transforms the first set of combustion parameters into a second set of combustion parameters. The control module controls fuel injection of the engine based on the second set of combustion parameters, and controls oxyhydrogen production and injection based on the second set of combustion parameters. The controlled fuel injection and the controlled oxyhydrogen production and injection contribute to an improved performance of said engine during combustion. A method of improving the performance of a combustion engine and a method of injecting oxyhydrogen into a combustion engine are also disclosed.

### CROSS-REFERENCE TO RELATED APPLICATION

This application claims benefit under 35 U.S.C. §119(e) of U.S. Provisional Application having Ser. No. 61/354,732 filed Jun. 15, 2010, which is hereby incorporated by reference herein in its entirety.

### FIELD OF INVENTION

This invention relates to a system and method of improving the performance of a combustion engine, in particular related to a system and method of increasing combustion efficiency of a combustion engine by mixing fuel and air with oxyhydrogen for combustion.

### BACKGROUND OF INVENTION

Some combustion engines mix hydrogen with air and fuel for combustion. However, the amount and quality of hydrogen produced and also the composition of the mixture may not be optimal. An improvement is hence desired.

### SUMMARY OF INVENTION

In the light of the foregoing background, it is an object of the present invention to provide a system control unit for improving the performance of a combustion engine.

Accordingly, the present invention, in one aspect, is a system for improving the performance of a combustion engine comprising a system control unit. The system control unit comprises an input module, a transform module and a control module all interconnected to each other. The input module obtains a first set of combustion parameters of the engine through at least one sensor. The transform module then transforms the first set of combustion parameters into a second set of combustion parameters. The control module controls fuel injection based on the second set of combustion parameters, and also controls oxyhydrogen production and injection based on the second set of combustion parameters. The controlled fuel injection and the controlled oxyhydrogen production and injection contribute to an improved performance of the engine during combustion.

In an exemplary embodiment of the present invention, the system further comprises an oxyhydrogen production unit adapted to produce oxyhydrogen. The oxyhydrogen production unit is electrically connected to the control module of the system control unit for controlling the oxyhydrogen production.

In an exemplary embodiment of the present invention, the oxyhydrogen production unit comprises a temperature sensor. The temperature sensor is electrically connected to the system control unit. The system control unit monitors the temperature within the oxyhydrogen production unit through the temperature sensor. When the temperature is beyond a predetermined temperature range, the system control unit controls an activation of a temperature regulation system to regulate the temperature within the oxyhydrogen production unit.

In another exemplary embodiment, a scheme of oxyhydrogen production is optimized through a back end computer. The back end computer is adapted to display a state of the oxyhydrogen production unit and a state of the engine through the sensors, and allow an installer to manipulate the system control unit for determining an oxyhydrogen production rate in the oxyhydrogen production unit.

According to another aspect of the present invention, a method of improving the performance of a combustion engine is disclosed. The method obtains a first set of combustion parameters of the engine of the vehicle and transforms the first set of combustion parameters into a second set of combustion parameters. The method controls oxyhydrogen production and injection and also controls the required amount of fuel to be injected into the engine based on the second set of combustion parameters. The controlled fuel injection and the controlled oxyhydrogen production and injection contribute to an improved performance of the engine during combustion.

In yet another aspect of the present invention, a method of injecting oxyhydrogen into a combustion engine is provided in which a gas injector with a one-way pumping action between an oxyhydrogen production unit and a combustion engine is provided. Then, signal from a system control unit is sent to the gas injector to control a rate of said oxyhydrogen injection.

There are many advantages to the present invention. One of the advantages is that by mixing oxyhydrogen with air and fuel, the combustion of the mixture is more efficient, and a more efficient combustion means less fuel is needed for the same power output if not better; thus, the performance of the vehicle is then improved. A more efficient combustion also leads to another advantage that less harmful emissions from incomplete combustion such as carbon monoxide is produced, creating less pollution to the environment.

### BRIEF DESCRIPTION OF FIGURES

FIG. 1 is a block diagram of an oxyhydrogen fuel system according to an embodiment of the present invention.

FIG. 2a is an exploded diagram of an oxyhydrogen production unit according to an embodiment of the present invention.

FIG. 2b is an exploded diagram of an oxyhydrogen production unit according to another embodiment of the present invention.

FIG. 3 is a block diagram of a temperature regulation system according to an embodiment of the present invention.

FIG. 4 is a block diagram of a water level regulation system according to an embodiment of the present invention.

FIG. 5 is a block diagram of an ON/OFF panel according to an embodiment of the present invention.

FIG. 6 is a flow chart of the parameter control of the oxyhydrogen fuel system according to an embodiment of the present invention.

FIG. 7 is an exploded diagram of a system for improving the performance of a combustion engine according to an embodiment of the present invention.

### DETAILED DESCRIPTION OF THE PREFERRED EMBODIMENTS

As used herein and in the claims, “comprising” means including the following elements but not excluding others. “Engine” refers to internal combustion (injection) engine. “Oxyhydrogen” means a mixture of hydrogen gas (H₂) and oxygen gas (O₂). “Fuel” refers to conventional fuel used in combustion engines, including but is not limited to petroleum, diesel, liquefied petroleum gas (LPG), compressed natural gas (CNG), etc. “Electrolytic solution” refers to a mixture of distilled water with a chemical such as potassium hydroxide such that the mixture is conductive for electrolysis purposes. All amounts and rates in the specification are interchangeably used here, as one value can be conveniently determined from the other through simple calculations.

The embodiments described herein use a vehicle as an example of application of the inventive ideas of the present invention. A person skilled in the art can modify the details to implement the idea in other fields of technology, and would still fall in the scope of the present invention.

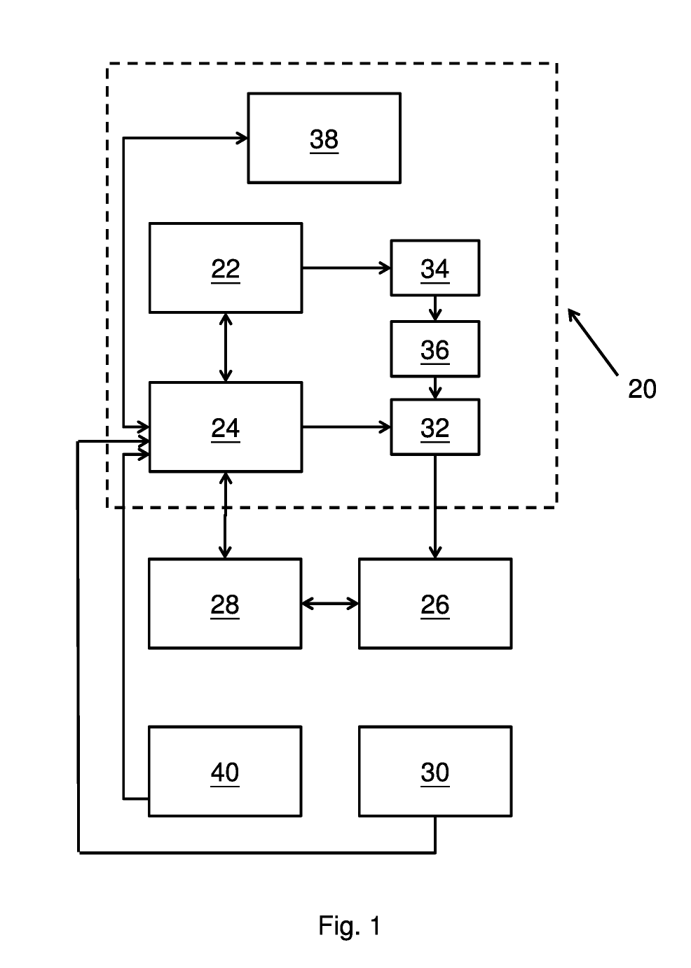

Referring to FIG. 1, one embodiment of the present invention is an oxyhydrogen fuel system 20 for improving the performance of a vehicle comprising a system control unit 24 for improving the combustion performance of an engine 26. The system control unit 24 comprises an input module, a transform module and a control module all interconnected to each other. The input module obtains a first set of combustion parameters of the engine 26 through at least one sensor 30. The transform module transforms the first set of combustion parameters to a second set of combustion parameters based on predetermined data stored within the transform module. The control module controls fuel injection based on the second set of combustion parameters and also controls oxyhydrogen production and injection based on the second set of combustion parameters. In one embodiment, the control module directly controls the fuel injection. In yet another embodiment, the control module indirectly controls the fuel injection through the vehicle ECU 28. The controlled fuel injection and the controlled oxyhydrogen production and injection contribute to an improved performance of the engine 26 during combustion.

In another embodiment, the system 20 further comprises an oxyhydrogen production unit 22. The control module of the system control unit 24 is electrically connected to the oxyhydrogen production unit 22 for controlling oxyhydrogen production in the oxyhydrogen production unit 22. In an exemplary embodiment, the oxyhydrogen production unit 22 is adapted to produce oxyhydrogen by electrolysis of an electrolytic solution, and the system control unit 24 controls such oxyhydrogen production by controlling the electric current to the oxyhydrogen production unit 22 for electrolysis.

In one embodiment, the input module of the system control unit 24 reads the first set of combustion parameters by electrically connecting to the sensors 30 (the system control unit can be reprogrammed if the number of sensors changes). The control module sends the set of transformed second set of combustion parameters to the vehicle ECU 28 to replace the original set of combustion parameters. In one exemplary embodiment, the system control unit 24 controls the fuel injection into the engine 26 indirectly by reading the signals at any one time from the sensors 30 and sending back the transformed parameters to the vehicle ECU 28 to reduce the amount of fuel injected to the desired level.

In one embodiment, the system 20 works by collecting various signals or data from an operating engine 26 via the sensors 30 with the system control unit of the oxyhydrogen fuel system 20 (i.e. System control unit 24). After the engine 26 and the system 20 are switched to the “ON” mode, operating statistics of the engine 26 is collected by the system control unit 24 from the engine 26 via the sensors 30 (i.e. the first set of combustion parameters). The system control unit 24 then determines the appropriate amount of oxyhydrogen required to be injected into the engine 26, and sends signals to control the electric current that enters to the oxyhydrogen production unit 22 to produce the amount of oxyhydrogen needed as determined by the system control unit 24. The oxyhydrogen generated then flows through the pre-installed piping and injection unit and enters into the engine 26. At the same time the system control unit 24 obtains signals from the sensors 30 to enable the vehicle ECU 28 to modulate the amount of fuel needed to be injected into the engine 26 to ensure efficient fuel and oxyhydrogen combustion. By achieving efficient combustion, the system will achieve lower emission through reduction of fuel assumption and more efficient combustion process. In one exemplary embodiment, additional safety device such as anti-flashback device and fuel filter is installed to prevent flashback into the system.

In an exemplary embodiment, the first set of combustion parameters comprises at least one of the following parameters: mass air pressure (MAP), mass air flow (MAF), oxygen flow into the engine, throttle position, and a combination thereof. The sensors for at least one of the above parameters are found in a conventional vehicle. In an exemplary embodiment, the second set of combustion parameters comprises the same type of parameters as the first set of combustion parameters, electric current for controlling said oxyhydrogen production, and a combination thereof.

In one embodiment, the system control unit 24 transforms the first set of combustion parameters into the second set of combustion parameters and sends to the vehicle ECU 28 to control the amount of fuel to inject into the engine 26. The transformed set of combustion parameters is determined such that the vehicle ECU 28 injects a reduced amount of fuel into the engine 26 relative to the original value based on this set of manipulated or transformed parameters. In an exemplary embodiment, the transformed parameter is a lowered MAP sensor reading relative to the original MAP sensor reading. In different embodiments, the lowered reading can be referred to a lookup table for the particular MAP sensor reading, based on a multiplication factor or based on other predetermined rules.

In one embodiment, the system 20 comprises a function for controlling whether the original combustion parameters or the transformed parameters should be sent to the vehicle ECU 28.

In one embodiment, the system control unit 24 controls the amplitude of the electrical current needed for the oxyhydrogen production unit 22 to produce oxyhydrogen at a predetermined rate. The system control unit 24 then draws the electrical current needed from the vehicle battery 40 to the oxyhydrogen production unit 22 for oxyhydrogen production. In an exemplary embodiment, the current is selected from a plurality of predetermined values based on the vehicle.

In an exemplary embodiment, the system 20 further comprises an injection unit or referred to as an oxyhydrogen injector 32. The injector dosifies the oxyhydrogen produced from the oxyhydrogen production unit 22 and controls the injection of oxyhydrogen into the engine 26 through its one-way pumping action of oxyhydrogen in doses at high speed at the air intake of the engine 26. The oxyhydrogen injector 32 is electrically connected to the system control unit 24 for controlling the operation of the oxyhydrogen injector 32. In an alternative embodiment, there is a plurality of oxyhydrogen injectors 32, one for each cylinder of the combustion engine. In one embodiment, the system control unit 24 controls the operation of the oxyhydrogen injector 32 by sending a pulse width modulated (PWM) signal to the oxyhydrogen injector 32. The pulse width of the PWM signal is determined based on factors such as pressure within the oxyhydrogen production unit 22. In one further embodiment, the oxyhydrogen injector 32 injects oxyhydrogen into the air intake of the engine 26 only when the PWM signal is high.

In an exemplary embodiment, the structure of the oxyhydrogen injector 32 is the same as a conventional gas injector. Such injectors are able to inject oxyhydrogen at high speed, where an advantage is that less oxyhydrogen will be diffused away due to low pressure, making the injection of oxyhydrogen more efficient. In another embodiment, the oxyhydrogen injector 32 directly injects oxyhydrogen into the combustion chamber of the engine, where diffusion of oxyhydrogen may not be a concern but modifications to the original injectors may be needed.

In one embodiment, the system further comprises a flashback arrestor 34 and a fuel filter 36 along a gas hose between the oxyhydrogen production unit 22 and the engine 26. The flashback arrestor 34 prevents any spark or flames from the engine 26 to reach the oxyhydrogen production unit 22, whereas the fuel filter 36 prevents oxyhydrogen water vapor from entering the engine 26. In an exemplary embodiment, the oxyhydrogen injector 32 also functions as a flashback arrestor.

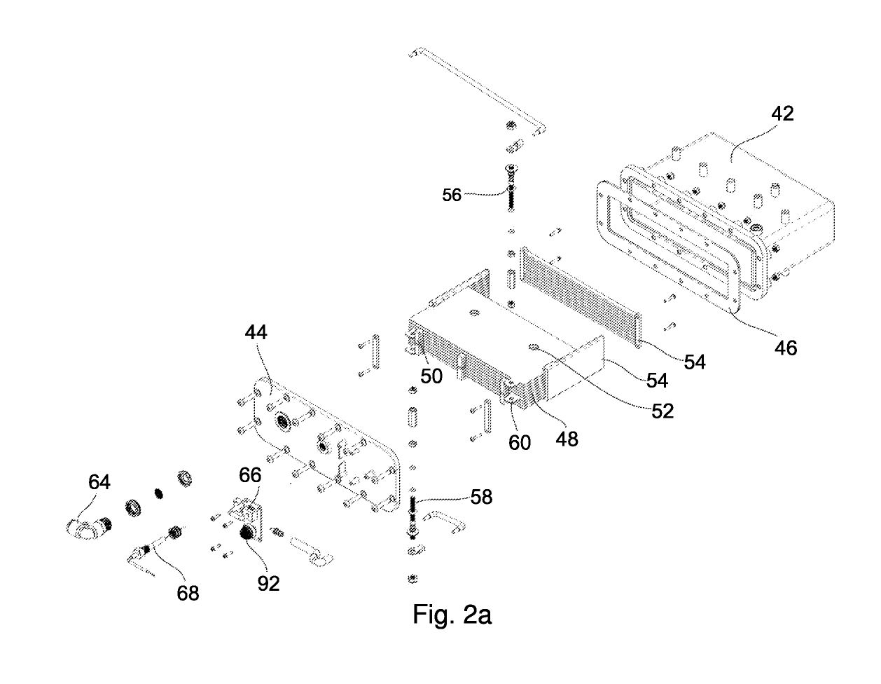

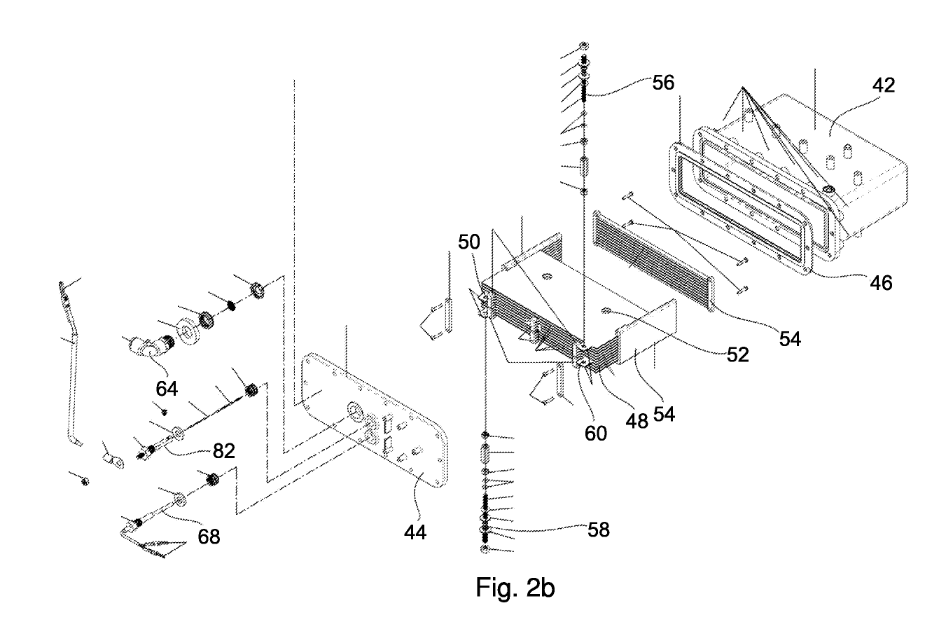

In two exemplary embodiments as shown in FIGS. 2a and 2b respectively, the oxyhydrogen production unit 22 comprises a oxyhydrogen production unit case 42 (“case”) and a oxyhydrogen production unit cover 44 (“cover”) covering the case, with a rubber washer 46 disposed between the case 42 and the cover 44 for preventing water and gas leakage. Enclosed within the case 42 is a plurality of stainless steel plates 48 arranged in a parallel configuration, with at least one divider 50 attached to the plates 48 to ensure that the distance between adjacent plates are uniform. Two openings 52 are opened in each of the plurality of stainless steel plates 48 to enhance water flow within the unit 22. A U-shaped plate holder 54 with a plurality of trenches is provided for the plurality of stainless steel plates 48 to sit thereon, with the U-shaped plate holder 54 holding the stainless steel plates 48 in place through the trenches.

In this exemplary embodiment, a cathode 56 and an anode 58 are provided, each connecting to extended areas 60 of at least one stainless steel plate 48 such that the plurality of stainless steel plates 48 forms alternating cathodes and anodes. The two electrodes 56, 58 are also connected to the vehicle battery 40 shown in FIG. 1. The extended areas 60 are at two sides of a top part of the stainless steel plates 48. The positioning of the extended areas 60 along with a plurality of screw nuts are used for avoiding explosion. In a specific embodiment, there are ten stainless steel plates 48 in the oxyhydrogen production unit. Hydrogen and oxygen are mixed together to form oxyhydrogen as they are produced, and outputs through a gas output hose 64.

In one embodiment, the case 42 is made of a mixture of polyamide and fiberglass, the cover 44 is made of polycarbonate, the U-shape holder 54 is made of high density polyethylene and the electrodes 56, 58 are made of stainless steel.

In a specific embodiment, the oxyhydrogen production unit 22 produces 1.2 to 3.5 liters of oxyhydrogen per minute at a current of 15 to 35 A and a voltage of 12 to 24V. The electrolytic solution used is a mixture of 0.5 g-3.5 g KOH mixed with 750 cc of distilled water. In other specific embodiments, the oxyhydrogen production unit 22 produces 1.2 liters of oxyhydrogen per minute using 12V, 25 A and 10 plates, or produces 1.7 liters at 12V, 25 A and 13 plates, or produces 2.5 liters at 24V, 20 A and 19 plates, or 3.5 liters at 110V, 9 A and 29 plates.

In an exemplary embodiment, the oxyhydrogen production unit 22 of the system 20 comprises a pressure sensor 66 (not shown in FIG. 2b). The pressure sensor 66 is electrically connected to the system control unit 24 such that the system control unit 24 monitors the pressure within the oxyhydrogen production unit 22 through the pressure sensor 66. When the pressure within the oxyhydrogen production unit 22 is beyond a predetermined pressure range, the system control unit 24 will regulate the rate of oxyhydrogen production until the pressure resumes back within the predetermined pressure range. This regulation overrides the normal control of oxyhydrogen production.

The predetermined pressure range is dependent on the type of vehicle. In one exemplary embodiment the low end of the pressure range is 3 psi and the high end of the pressure range is 15-20 psi. If the pressure is too low, the oxyhydrogen produced is unable to reach the engine 26, while if the pressure is too high, there is a danger that the oxyhydrogen production unit 22 may be damaged.

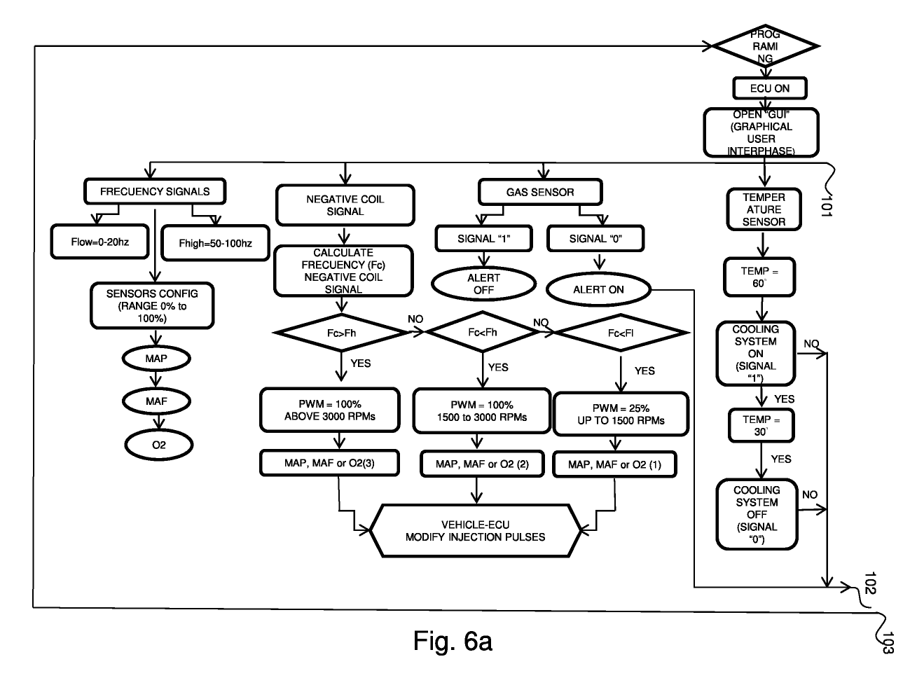

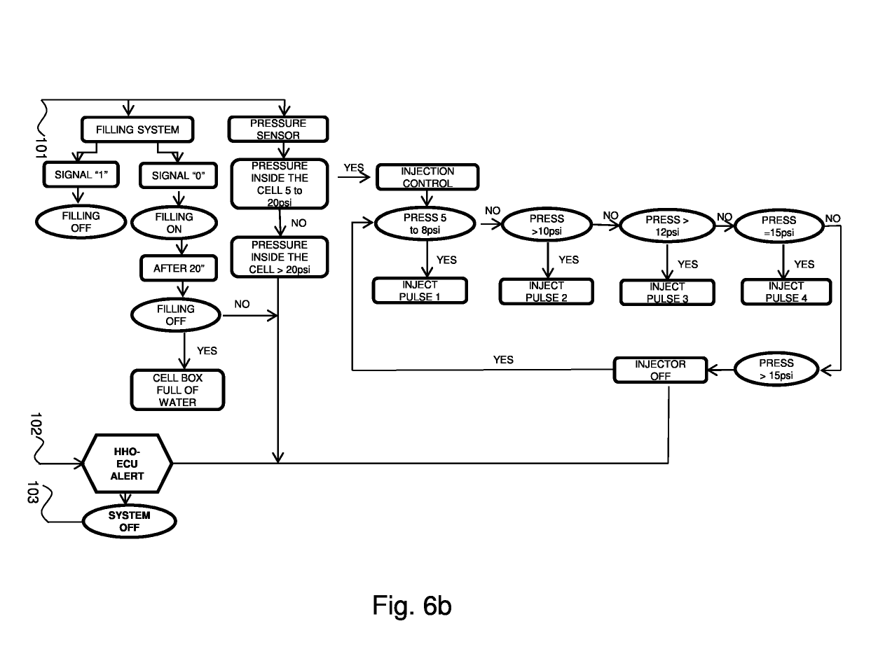

In an exemplary embodiment, the injection of oxyhydrogen into the engine 26 is determined by the pressure inside the oxyhydrogen production unit 22. A flow diagram of the algorithm for pressure control, together with controls on other parameters, is summarized in FIG. 6. The injection of oxyhydrogen is split into four configurations dependent on the pressure. The four configurations correspond to pressures of 5-8 psi, 8-10 psi, 10-12 psi and 12-15 psi respectively. The four configurations differ by pulse width and also frequency of pulses. If the pressure is over 15 psi, the system control unit 24 will force the oxyhydrogen production unit 22 to switch off. Oxyhydrogen continues to pump into the engine 26 until the pressure is back to 5-8 psi. If the pressure is over 20 psi or the oxyhydrogen production unit 22 does not switch off in the previous situation, the system 20 is shut down and an alert signal is sent to the user.

In an exemplary embodiment, the oxyhydrogen production unit 22 comprises a temperature sensor 68. The temperature sensor 68 is electrically connected to the system control unit 24 such that the system control unit 24 monitors the temperature within the oxyhydrogen production unit 22 through the temperature sensor 68. When the temperature is beyond a predetermined temperature range, the system control unit 24 controls an activation of a temperature regulation system 70 to regulate the temperature within the oxyhydrogen production unit 22.

The temperature within the oxyhydrogen production unit 22 is very important to the quality of the oxyhydrogen produced. As mentioned above, oxyhydrogen is produced in the oxyhydrogen production unit 22 by electrolysis of the electrolytic solution. During electrolysis, ideally hydrogen is produced at the cathode and oxygen is produced at the anode. If the temperature is too low, hydrogen molecules tend to drift to the anode, and if the temperature is too high, the oxygen molecules tend to drift to the cathode. In both cases, the yield of oxyhydrogen is reduced. Both situations are detrimental to the performance of the oxyhydrogen production unit 22. In an exemplary embodiment, the predetermined temperature range is 30 to 60 degrees Celsius. In other embodiments, the temperature range can vary depending on the environment or condition of the vehicle.

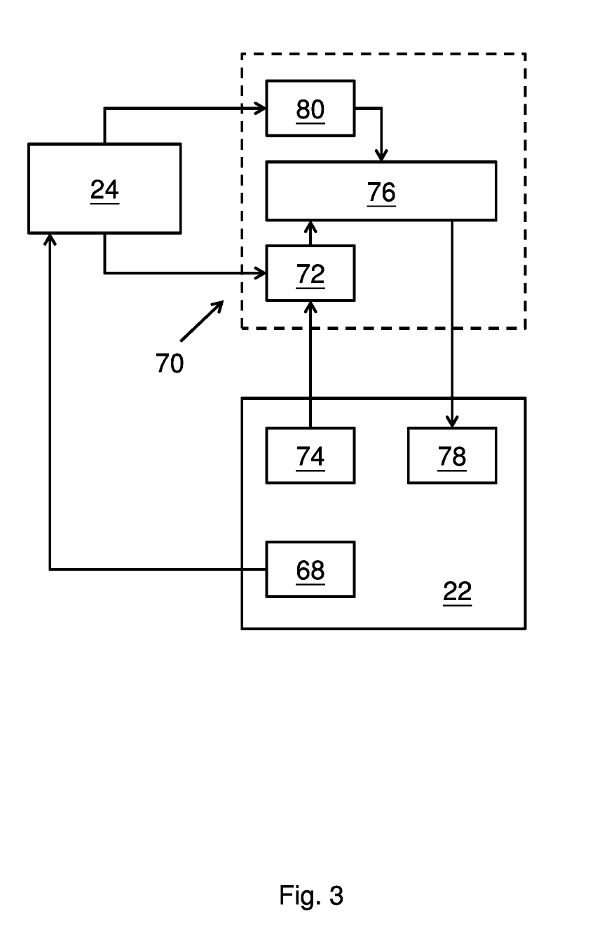

In one embodiment as shown in FIG. 3, the temperature regulation system 70 comprises a pump 72 connected to a water outlet 74 of the oxyhydrogen production unit 22, a length of pipe 76 in which one end thereof is connected to the pump 72 and another end thereof is connected to a water inlet 78 of the oxyhydrogen production unit 22, and at least one fan 80 for blowing cold air onto a section of the pipe 76.

When the temperature within the oxyhydrogen production unit 22 is over the predetermined temperature range, the system control unit 24 activates the temperature regulation system 70. First, the system control unit 24 activates the pump 72 to move a volume of water away from the oxyhydrogen production unit 22 through the water outlet 74. As the water is from the oxyhydrogen production unit, the temperature thereof should be over the predetermined temperature range. Then, the pumped water flows through the section of pipe 76 where the system control unit 24 activates the fan 80 to blow onto the pipe 76. As such, when the water flows through the pipe 76, heat is exchanged between the hot water, the pipe surface and the cold air blown onto the pipe 76, thereby cooling down the temperature of the water flowing inside the pipe 76. This section of pipe 76 obviously should be as long as possible for maximizing the surface area against cold air, and in one embodiment the section is S-shaped such to reduce the total volume occupied and also reduce the number of fans 80 needed. The pipe 76 is preferably, in one exemplary embodiment, made of a thermoconductive material such as copper. The cooled water flows back into the oxyhydrogen production unit 22 through the water inlet 78 and thus lowers the overall temperature of the oxyhydrogen production unit 22. The temperature regulation system 70 can be activated for a predetermined period of time, or can be activated until the temperature reaches a predetermined value such as the low end of the predetermined temperature range.

In one embodiment, the water outlet 74 and the water inlet 78 of the temperature regulation system 70 are disposed at diagonal corners near the bottom of the oxyhydrogen production unit 22. This configuration maximizes the distance between the water outlet 74 and the water inlet 78 such that the temperature difference between water at the water outlet 74 and the water inlet 78 is the greatest, and also optimizes the circulation of water within the oxyhydrogen production unit 22, hence maximizing the performance of the temperature regulating system 70. The water outlet 74 is installed near the bottom of the oxyhydrogen production unit 22 such that water can be pumped therefrom when the water level is low, and the water inlet 78 is installed near the bottom of the oxyhydrogen production unit 22 to prevent oxyhydrogen produced from the oxyhydrogen production unit 22 from escaping through the water inlet 78.

In an exemplary embodiment, the oxyhydrogen production unit 22 comprises a water level sensor 82. In one embodiment as shown in FIG. 2a, the one single sensor 68 is used for monitoring both the temperature and the water level. In yet another embodiment, temperature sensor 68 and water level sensor 82 are separate parts as shown in FIG. 2b. The water level sensor 82 is electrically connected to the system control unit 24 such that the system control unit 24 monitors the water level within the oxyhydrogen production unit 22 through the water level sensor 82. When the water level is beyond a predetermined water level range, the system control unit 24 controls an activation of a water level regulation system 84 to regulate the water level within the oxyhydrogen production unit 22. In one embodiment, the predetermined water level range is 90% to 95%.

As oxyhydrogen is continuously produced from water in the oxyhydrogen production unit, water is continuously consumed in the process. It is needed to keep the water level at an operable range at all times to ensure continuous and swift production of oxyhydrogen. In one embodiment, only the situation where the water level is below the predetermined water level range is considered below.

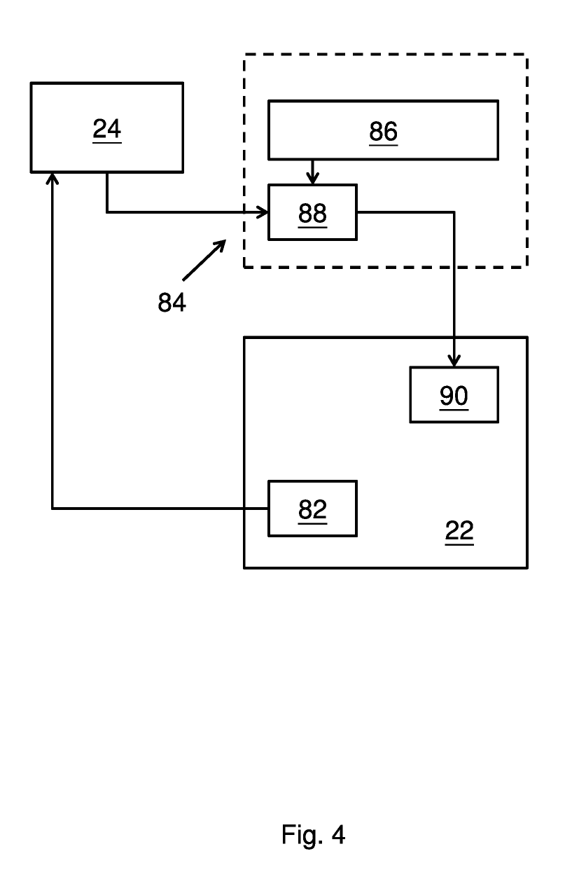

In such embodiment as shown in FIG. 4, the water level regulation system 84 comprises a water tank 86, a pump 88 connected to the water tank 86, and a pipe (not shown) with one end thereof connected to the pump 88 and another end thereof connected to a water refill inlet 90 of the oxyhydrogen production unit 22. When the water level is below a predetermined water level, the system control unit 24 sends a signal to pump 88 and activates the pump 88 to pump water from the water tank 86 to the oxyhydrogen production unit 22. In one embodiment, the predetermined water level at which the pump 88 will be activated is 90% of the height of the stainless steel plates 48 of the oxyhydrogen production unit 22. The activation stops either after a predetermined period of time (e.g. 20 seconds) or after a predetermined volume of water has been transferred.

In one embodiment, the water refill inlet 90 of the water level regulation system 84 is disposed near a bottom of the oxyhydrogen production unit 22 to prevent oxyhydrogen produced from escaping through the water refill inlet 90. In another embodiment, a one way valve is installed at the water refill inlet 90 to prevent water from flowing back to the water tank 86.

In an exemplary embodiment, the oxyhydrogen production unit 22 further comprises a gas sensor 92 (not shown in FIG. 2b). The gas sensor 92 is electrically connected to the system control unit 24 such that the system control unit 24 detects for any gas leaks from the oxyhydrogen production unit 22 through the gas sensor 92. In one embodiment, when a gas leak is detected, the system control unit 24 automatically shuts off the oxyhydrogen production unit 22.

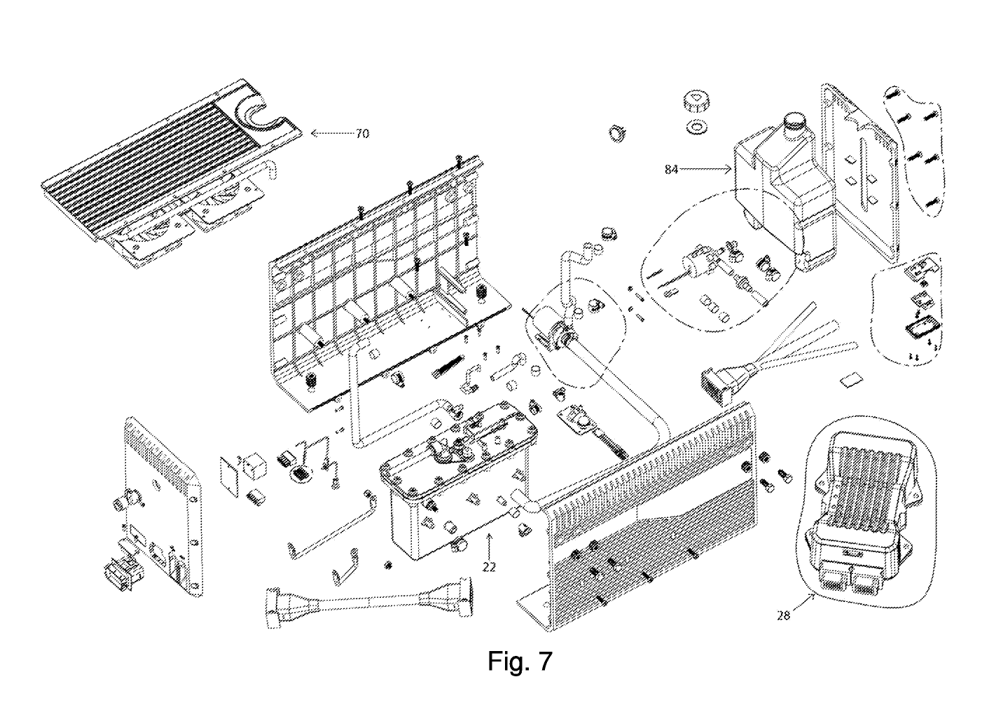

In one embodiment of the instant invention as shown in FIG. 7, the overall oxyhydrogen fuel system 20 is shown in which major parts of the system 20 such as the oxyhydrogen production unit 22, the vehicle ECU 28, the temperature regulation system 70, and the water level regulation system 84, and the connection thereof, are illustrated as an example.

In a specific embodiment, the oxyhydrogen production unit is designed to produce 1.2 to 3.5 liters of oxyhydrogen per minute using voltage and amperage ranging from 12 to 24V and 15 to 35 A respectively. Such oxyhydrogen production requires a chemical mixture of potassium hydroxide in the range of 0.5 g-3.5 g mixed with 750 cc of distilled water. The dimension of oxyhydrogen production unit is around 255 (length)×96 (width)×147 (height) mm. The dimension of stainless steel plate with electrode is around 206 (length)×118 (height)×1.2 (width) mm. The dimension of stainless steel plate without electrode is around 206 (length)×103 (height)×1.2 (width) mm Case material used for the oxyhydrogen production unit is a specific mixture of polyamide and fiberglass for robustness enhancement and better heat resistance. The cover for the oxyhydrogen production unit is mixture of polycarbonate and polybutylene terephtalate U-shaped stainless steel (316L) plate holder is made of high-density polyethylene with 10 trenches running along the length on the interior of the holder. The 10 trenches are designed for the sitting of the 10 stainless steel plates (“plates”).

Opposing pair(s) of electrodes is(are) situated on the extended areas of the plates. In one embodiment, two electrodes are situated on the extended areas of the first and seventh plates whereas the two opposing electrodes are situated on the extended areas of the fourth and tenth plates. The two pairs of electrodes are used to enhance the conductivity of electrical aspect which in turn would dramatically increase the amount of oxyhydrogen produced. The circle and positioning of the extended areas along with the screw nuts are used as safety features.

Two holes, each with a diameter of 12 mm, are positioned on each of the ten plates to allow better circulation between the plates and also to maintain the water level even throughout the intervals of the plates.

Acrylonitrile butadiene styrene or polycarbonate with polybutylene terephtalate dividers are used for separating each plate at the same interval of 2.8 mm. The benefit of such arrangement is to avoid affecting the efficiency of the oxyhydrogen production.

Sensors for water level, pressure and temperature are installed for the purposes of maintaining the efficiency of the oxyhydrogen production and for safety concerns. A gas detector is also installed for the safety concerns. The water inlet and water outlet for the cooling system are located at diagonal corners near the bottom part of the front and rear panel of the case. This is to assist better cooling and circulation of the unit. Also, the water inlet connected to the water tank is placed near the bottom part of the case so as to avoid the oxyhydrogen generated from escaping through the inlet. A one way valve is installed to avoid water from flowing back to the water tank.

A rubber washer is also installed to seal the box from gas and water leakage.

Further, a cooling system is also installed and designed to control the operating temperature of the chemical, while a water tank is installed for refilling the oxyhydrogen production unit

In an exemplary embodiment, the system control unit 24 further regulates the oxyhydrogen production based on a state of an accelerator pedal of the vehicle.

When a driver steps on the pedal, the air injection rate is increased. The vehicle ECU 28 detects this change through the MAP sensor 30, and then increases the rate of fuel entering the engine proportionally. Alternatively, the vehicle ECU 28 has a TPS sensor to detect the change to the position of the throttle.

In an exemplary embodiment, the fuel injection rate is regulated by the engine speed or RPM. The input module of the system control unit 24 reads the RPM data of the engine 26 using the frequency signal from the negative coil of the engine, and the fuel injection rate is regulated based on the read signal. In a specific embodiment, there is a high RPM threshold and a low RPM threshold, where three fuel injection settings are provided for the engine RPM being higher than the high threshold, lower than the low threshold or in between the two thresholds. In an exemplary embodiment, the setting includes the PWM width of the oxyhydrogen injector 32 into the engine 26 and the value of the transformed parameter for controlling the fuel injection rate. In a specific embodiment, the high threshold is 3000 rpm and the low threshold is 1500 rpm as shown in the flow chart of FIG. 6.

In yet another embodiment, as further illustrated in the flow chart of FIG. 6, the low frequency end for the negative coil is 0-20 Hz, whereas the high end of the frequency value for the negative coil is 50-100 Hz.

In one embodiment, other than the rate of oxyhydrogen production, other parameters such as timing of oxyhydrogen injection can also be controlled from this signal.

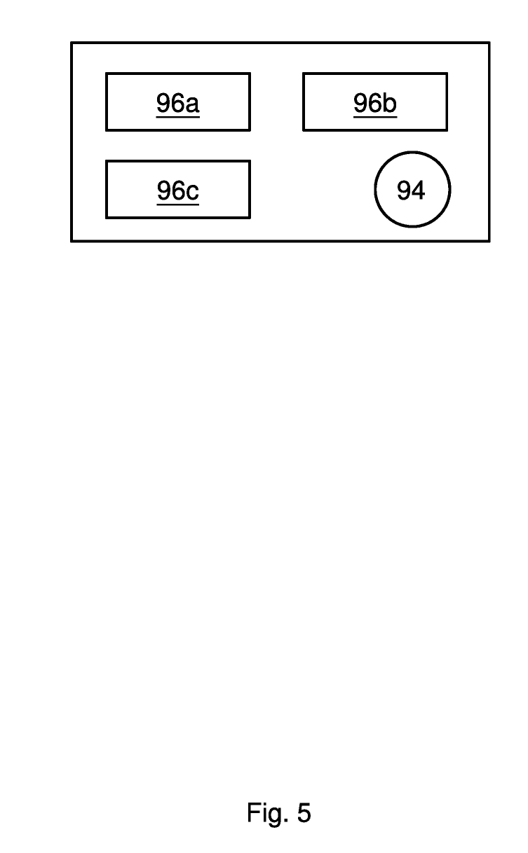

Referring back to FIG. 1, in an exemplary embodiment, the system further comprises an ON/OFF panel 38 electrically connected to the system control unit 24. As shown in an exemplary embodiment in FIG. 5, the ON/OFF panel 38 comprises an activation button 94 for activating or deactivating the oxyhydrogen fuel system 20, and also at least one indicator for alerting the user about a state of the oxyhydrogen fuel system 20.

In one embodiment, the ON/OFF panel 38 is located in front of the driver's seat such that the user or driver can be easily alerted or can easily access the activation button 94. As shown in FIG. 5, the indicators can include an indicator 96a for indicating whether the system is working normally, an indicator 96b for indicating whether the water level in the water tank is low and needs to be refilled, an indicator 96c for indicating whether service or maintenance of the system is needed, or a combination of the above. In one embodiment, the indicators are light-emitted diodes (LEDs) that visually alert the user when the system 20 needs the user's attention.

In a further embodiment, the system 20 is shown to be working normally if all of the sensors show that the respective parameters are in the predetermined ranges, and the system is shown to be needing service when a gas leak is detected, the pressure is too high or the temperature regulation system, the water level regulation system is not working properly, or a combination of any of the above scenarios.

In an exemplary embodiment, a back end computer is provided to calibrate or optimize the oxyhydrogen production for each individual vehicle during the installation and initial setup of the system. The back end computer is connected to the system control unit 24, and displays the various signals to a user (e.g. a mechanic or technician). The signals can include the signal of each of the sensors of the oxyhydrogen production unit 22, the MAP/MAF/oxygen/TPS sensor of the vehicle, the rate of oxyhydrogen or fuel production and/or the electrical current supplying to the oxyhydrogen production unit 22, and/or other relevant data such as harmful gas emission rate from the exhaust pipe of the vehicle. In one embodiment, the back end computer can be adapted such that the user can do programming therewith.

Apart from displaying data to the user, the back end computer is programmed to allow the installer to manipulate the system control unit 24 for optimization. As the system control unit 24 can communicate with the oxyhydrogen production unit 22 and the vehicle ECU 28, manipulation of the system control unit 24 can also control the oxyhydrogen production unit 22 and the vehicle engine 26 through the vehicle ECU 28. For example, the ratio of oxyhydrogen injection to fuel injection can be manipulated and tested until a desired ratio or a specific rate is determined. The desired ratio or rate can be based on fuel efficiency, power output, or a balance between the both.

In a specific embodiment, the initial setup is performed at multiple data points having different speeds and/or rpms.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, the engine can be a gasoline engine or a diesel engine, and can be a 2-stroke engine, a 4-stroke engine or a rotary engine. Engines other than combustion engine can also be used with suitable modifications known to one skilled in the art.

While the above embodiments use a vehicle as an example, one skilled in the art can modify the system within the teachings of this specification to operate in other fields of technology that utilizes a combustion engine.

What is claimed is:

1. A system for improving the performance of a combustion engine comprising a system control unit, said system control unit comprising:
a) an input module obtaining a first set of combustion parameters of said engine through at least one sensor;
b) a transform module transforms said first set of combustion parameters into a second set of combustion parameters; and
c) a control module controlling fuel injection of said engine based on said second set of combustion parameters, and controlling oxyhydrogen production and injection based on said second set of combustion parameters;
wherein said controlled fuel injection and said controlled oxyhydrogen production and injection contribute to an improved performance of said engine during combustion.

2. The system according to claim 1, wherein said first set of combustion parameters is selected from a group consisting of a mass air pressure, a mass air flow, an oxygen flow into said engine, and a combination thereof.

3. The system according to claim 1, wherein said second set of combustion parameters is selected from a group consisting of a mass air pressure, a mass air flow, an oxygen flow into said engine, an electric current for controlling said oxyhydrogen production, and a combination thereof.

4. The system according to claim 1, further comprising an oxyhydrogen production unit adapted to produce oxyhydrogen, said oxyhydrogen production unit is electrically connected to said control module of said system control unit for controlling said oxyhydrogen production.

5. The system according to claim 4, wherein said oxyhydrogen production unit further comprises a pressure sensor for monitoring a pressure inside said oxyhydrogen production unit; said pressure sensor being electrically connected to said system control unit, wherein said system control unit regulates said rate of oxyhydrogen production when said pressure is beyond a predetermined pressure range.

6. The system according to claim 4, wherein said oxyhydrogen production unit further comprises a temperature sensor for monitoring a temperature inside said oxyhydrogen production unit; said system further comprising a temperature regulation system for regulating said temperature inside said oxyhydrogen production unit, said temperature sensor being electrically connected to said system control unit, wherein said system control unit controls an activation of said temperature regulation system when said temperature is beyond a predetermined temperature range.

7. The system according to claim 6, wherein said temperature regulation system comprises a water pump connected to a water outlet of said oxyhydrogen production unit, a section of pipe with one end thereof connected to said water pump and another end thereof connected to a water inlet of said oxyhydrogen production unit, and at least one fan adapted to blow air onto said section of pipe to lower a temperature of said pipe, thereby also lowering a temperature of water flowing through said section of pipe.

8. The system according to claim 4, wherein said oxyhydrogen production unit is adapted to produce oxyhydrogen by electrolysis of water, said oxyhydrogen production unit further comprises a water level sensor for monitoring a water level inside said oxyhydrogen production unit; said system further comprising a water level regulation system for regulating said water level inside said oxyhydrogen production unit; said water level sensor being connected to said system control unit; wherein said system control unit controls an activation of said water level regulation system when said water level is beyond a predetermined water level range.

9. The system according to claim 8, wherein said water level regulation system comprises a water tank and a water pump connected to said water tank and connected to a water inlet of said oxyhydrogen production unit.

10. The system according to claim 4, wherein a scheme of oxyhydrogen production is optimized through a back end computer, said back end computer is adapted to display a state of said oxyhydrogen production unit and a state of said engine through the sensors, and allow an installer to manipulate said system control unit for determining an oxyhydrogen production rate in said oxyhydrogen production unit.

11. The system according to claim 4, wherein said oxyhydrogen production unit comprises:
a) a plurality of stainless steel plates arranged in a parallel configuration, two openings are opened in each of said plurality of stainless steel plates;
b) at least a pair of opposing electrodes, said electrode connected to at least one stainless steel plate such that said plurality of stainless steel plates form alternate cathodes and anodes, said cathode and said anode further connected to said system control unit; and
c) a gas hose disposed around said cathode for oxyhydrogen produced from said cathode to flow therethrough to said engine.

12. A method of improving the performance of a combustion engine, comprising the steps of:
a) obtaining a first set of combustion parameters of said engine;
b) transforming said first set of combustion parameters into a second set of combustion parameters;
c) controlling oxyhydrogen production and injection based on said second set of combustion parameters; and
d) controlling the required amount of fuel injection into said engine based on said second set of combustion parameters;
wherein said controlled fuel injection and said controlled oxyhydrogen production and injection contribute to an improved performance of said engine during combustion.

13. The method according to claim 12, wherein said system further comprises an oxyhydrogen production unit adapted to produce oxyhydrogen.

14. The method according to claim 13, further comprising the steps of monitoring a pressure within said oxyhydrogen production unit, and controlling said oxyhydrogen production when said pressure within said oxyhydrogen production unit is beyond a predetermined pressure range.

15. The method according to claim 13, further comprising the steps of monitoring a temperature within said oxyhydrogen production unit, and controlling an activation of a temperature regulating system when said temperature within said oxyhydrogen production unit is beyond a predetermined temperature range.

16. The method according to claim 13, further comprising the steps of monitoring a water level within said oxyhydrogen production unit, and controlling an activation of said water filling system when said water level is beyond a predetermined water level range.

17. A method of injecting oxyhydrogen into a combustion engine, comprising the steps of:
a) providing a gas injector with a one-way pumping action between an oxyhydrogen production unit and a combustion engine; and
b) sending signal from a system control unit to said gas injector to control a rate of said oxyhydrogen injection.

18. The method according to claim 17, wherein said signal is a pulse width modulated signal and a frequency and a pulse width thereof are determined by a pressure parameter of an oxyhydrogen production unit.
